(19) United States
(12) Patent Application Publication
(10) Pub. No.: US 2003/0064286 A1
(43) Pub. Date: Apr. 3, 2003

(54) Nonaqueous electrolyte battery and method of manufacturing same

(75) Inventors: Yasuhiro Yoshida, Tokyo (JP); Osamu Hiroi, Tokyo (JP); Tetsuyuki Kurata, Tokyo (JP); Takashi Nishimura, Tokyo (JP); Syoji Yoshioka, Tokyo (JP); Shigeru Aihara, Tokyo (JP); Daigo Takemura, Tokyo (JP); Hironori Kuriki, Tokyo (JP); Jun Aragane, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/158,151

(22) Filed: May 31, 2002

(30) Foreign Application Priority Data
Sep. 28, 2001 (JP) 2001-298877

(51) Int. Cl. H01M 2/08; H01M 2/02

(52) U.S. Cl. 429/184; 429/127; 429/176; 29/623.2; 29/623.4

(57) ABSTRACT

The present invention provides a nonaqueous electrolyte battery, of which impact resistance can be enhanced. The nonaqueous electrolyte battery comprising a electric power generating element, a baglike container, leads, and a resin for fixing the leads and an inner surface of the baglike container together.

### BACKGROUND OF THE INVENTION

1. Technical Field

The invention relates to a battery having a nonaqueous electrolyte. More specifically, the invention relates to a battery, of which impact resistance can be readily enhanced without application of a complex construction on a nonaqueous electrolyte battery, and a method of manufacturing the same.

2. Background Art

Demand for making portable electronic equipments small-sized and lightweight is significantly great, of which realization greatly depends upon improvement in performance of batteries. To meet this demand, a great variety of batteries have been developed and improved. A lithium ion battery being a non-aqueous electrolyte solution battery is a secondary battery, for which realization of high voltage and high energy are expected, and has been currently promoted for improvement. Also, a lithium metal battery, for which high energy density is expected, is being studied. Study for making batteries lightweight is being vigorously effected not only with respect to an electric power generating element of a battery but also with respect to a container for protection of a battery.

For the sake of lightening, containers adopt a can structure made of a metal such as stainless steel or the like having been conventionally used, a recent can structure made of lightweight and thin aluminum, and a structure such that a laminate film composed of a metal foil of aluminum or the like and a heat-sealable resin film is formed in the form of a bag.

Being small in mechanical strength as compared with conventional containers, such lightened container is in need of contrivance for ensuring reliability in the case where a battery is subjected to impact such as falling or the like and various types of deforming pressures. A container made of a laminate film is susceptible to damage due to thin filming and so is reinforced with a protective film or the like. A lightened container is low in rigidity and also in the function of protecting an electric power generating element of a battery contained therein. Therefore, there is a need of not only measures for damage against a container itself but also measures for protecting an electric power generating element of a battery contained therein. There have been proposed various ways to ensure reliability against impact and deforming pressures on an electric power generating element of a battery.

A method of bonding an electric power generating element and a container together is shown in, for example, Japanese Patent Laid-Open No. 93576/2001. This method can provide for an excellent resistance against impact and vibrations.

As disclosed in, for example, Japanese Patent Laid-Open No. 118566/2001, there has been also proposed a method of enhancing strength by mounting reinforcing members to lead portions taken out of an electric power generating element. When this method is used to collect and electrically connect a plurality of leads to terminals at the manufacture of batteries, it is possible to prevent breakage of leads at lead taken-out bases.

As for lightened containers, rigidity of a container is low and so forces for fixation of an electric power generating element contained therein are weak. Therefore, large shock or the like may cause positional deviation between an electric power generating element and a container to lead to damage against lead portions or the like, by which electric current is taken outside the container from the electric power generating element.

When it is tried to apply on a lightened container the way to bond an electric power generating element and a container together, there are caused problems that strong bonding with common adhesives and an adhesive material is made difficult due to the presence of a film layer for heat sealing on an inner surface of a laminate film and an increase in thickness due to bonding is not preferable in thin batteries assumed by a lightened container.

With the method of enhancing strength by mounting reinforcing members to lead portions taken out of an electric power generating element, it is difficult to incorporate into an battery container with a limited space, reinforcing members dimensioned sufficiently to enable surely suppressing deformation of lead portions. Further, since there is not expected an effect of suppressing positional deviation between an electric power generating element and a container, lead portions are liable to deform when impact is applied. Therefore, in the case of repeated impacts of large magnitude, there remains a fear that leads or neighboring portions thereof may be broken. Also, there is a disadvantage that much time is taken in mounting of the reinforcing members.

### DISCLOSURE OF THE INVENTION

The invention has been thought of in order to solve such problems, and provides a nonaqueous electrolyte battery, in which a container and an electric power generating element are simply and surely fixed together in a battery making use of a lightened container and damage can be suppressed even upon application of impact and deforming pressure, and a method of manufacturing the same.

This object and advantages are achieved by providing a novel and improved nonaqueous electrolyte battery comprising an electric power generating element, in which positive electrode plates and negative electrode plates are laminated, a baglike container receiving therein the electric power generating element and formed from a resin film, leads connected to the positive electrode plates and the negative electrode plates, respectively, and taken out of the baglike container through heat sealed portions of the baglike container, and a resin for fixing the leads and an inner surface of the baglike container together.

Further, according to one aspect of the invention, there is provided a method of manufacturing a nonaqueous electrolyte battery comprising an electric power generating element, in which positive electrode plates and negative electrode plates are laminated, a baglike container receiving therein the electric power generating element and formed from a resin film, and leads connected to the positive electrode plates and the negative electrode plates, respectively, and taken out of the baglike container through heat sealed portions of the baglike container, and wherein a resin is used to fix the leads and an inner surface of the baglike container together.

The above object and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view showing an example of a nonaqueous electrolyte battery, of which a baglike container is formed by a method of double folding a square-cut film sheet and heat sealing three sides thereof;

FIG. 2 is a perspective view showing an example of a nonaqueous electrolyte battery, of which a baglike container is formed by a method of heat sealing both opening portions of a cylindrical-shaped film;

FIG. 3 is a cross sectional view showing an area where one surface of leads and an inner surface of a baglike container are fixed together by means of a resin, in a nonaqueous electrolyte battery according to the invention;

FIG. 4 is a cross sectional view showing an area where both surfaces of leads and inner surfaces of a baglike container are fixed together by means of a resin, in a nonaqueous electrolyte battery according to the invention;

FIG. 5 is a cross sectional view showing an area where one surface of leads, an inner surface of a baglike container and an electric power generating element are fixed together by means of a resin, in a nonaqueous electrolyte battery according to the invention;

FIG. 6 is a cross sectional view showing an area where both surfaces of leads, inner surfaces of a baglike container and an electric power generating element are fixed together by means of a resin, in a nonaqueous electrolyte battery according to the invention;

FIG. 7 is a cross sectional view showing an area where a resin adheres to one surface of leads and an inner surface of a baglike container, in first to third examples of the invention;

FIG. 8 is a cross sectional view showing an area where a resin adheres to both surfaces of leads and an inner surface of a baglike container, in fourth and fifth examples of the invention;

FIG. 9 is a cross sectional view showing an area where both surfaces of leads, inner surfaces of a baglike container and an electric power generating element are fixed together by means of a resin, in fourth and fifth examples of the invention;

FIG. 10 is a view showing an example of the manufacture flowchart of a nonaqueous electrolyte battery in the case where a resin in flow condition being supplied to lead portions is a thermoplastic resin, in embodiment forms of the invention; and

FIG. 11 is a view showing an example of the manufacture flowchart of a nonaqueous electrolyte battery in the case where a resin in flow condition being supplied to lead portions is a thermosetting resin, in embodiment forms of the invention.

### BEST MODE FOR CARRYING OUT THE INVENTION

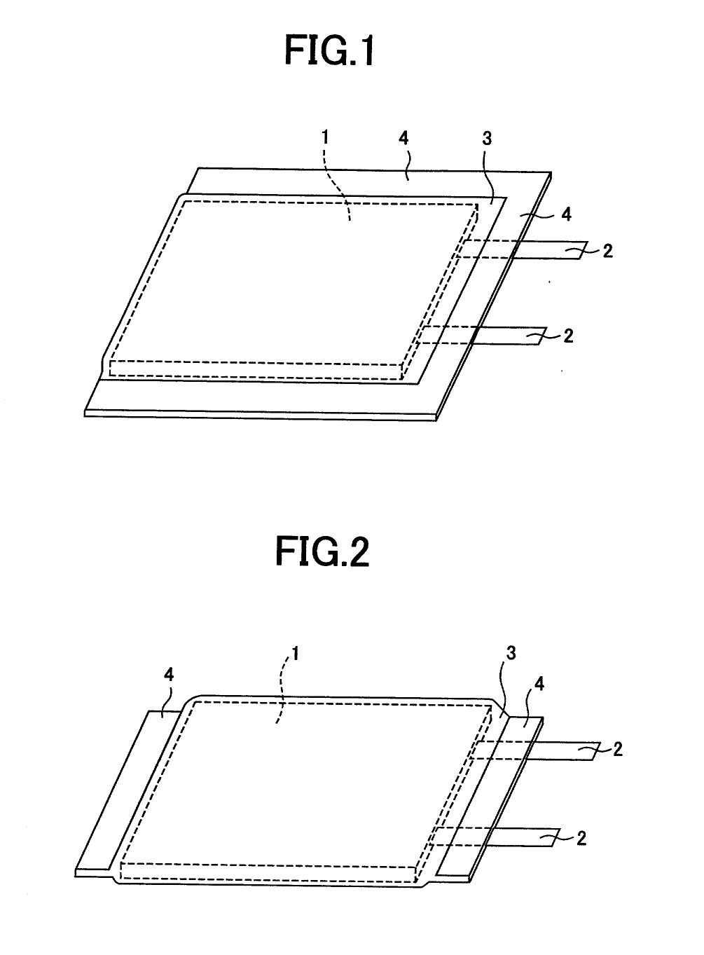

An explanation will be given to main constituent elements, constitution and a manufacturing method of a nonaqueous electrolyte battery according to the invention. In FIGS. 1 to 9, numeral 1 designates an electric power generating element; numeral 2 designates leads; numeral 3 designates a baglike container; numeral 4 designates a heat sealed portion; and numeral 5 designates a resin.

Electric Power Generating Element

Electrode plates in the invention are used which comprise an active material coated on a collector. Positive electrode plates can use, as an active material, ones having oxides of transition metals, for example, cobalt, manganese, nickel or the like, chalcogenides, or conjugated compounds thereof, various additional elements. While carbonaceous materials are preferably used in negative electrode plates, they can be used irrespective of chemical properties in a battery of the invention. An active material making use of metallic lithium is also usable. In the case of metallic lithium, an active material in the form of either powder or foil will do while other active materials are used in the form of powder. An active material having the particle size of 0.3 to 20 μm is usable. In particular, an active material having the particle size of 1 to 5 μm is preferable. In the case of the particle size being too small, an area of active material surfaces covered by an adhesive at the time of bonding becomes excessively large, so that an associated battery will be degraded in performance since doping and de-doping of lithium ions at the time of charging and discharging are not efficiently effected. In the case of the particle size being too large, it is not preferable because thin filming is not easy, the packing density is decreased, and irregularities on surfaces of electrode plates thus formed become large to make unfavorable bonding with a separator. A collector formed of a metal which is stable in a battery is usable, aluminum being preferably used for positive electrode plates and copper being preferably used for negative electrode plates. Any one of foil, mesh, expanded metal and the like is usable for the configuration of a collector. Leads connected to positive electrode plates and negative electrode plates may be ones formed from a metal such as aluminum, nickel or the like and mounted on a collector and ones comprising collector portions taken out and not coated with an active material.

An electric power generating element of a battery may be constructed such that positive electrode plates correspond closely to negative electrode plates and a gap therebetween is filled with an electrolyte or may be constructed such that planar elements overlap one another, or may be of winding pattern construction, or of folded construction or of composite construction of the above-mentioned constructions. Leads are taken out of edge surface portions of an electric power generating element, and when a plurality of electrode plates are stacked on one another, a plurality of leads taken out of the electrode plates are in many cases connected together and taken out of a battery container. In the case of being of winding pattern construction, or of folded construction, leads are in some cases taken out of portions on ends of cross sections of an electric power generating element when they are taken out of central portions of cross sections of the electric power generating element. In this manner, while there are various ways, in which leads are taken out, no specific problem is caused when leads taken out of positive electrode plates and negative electrode plates are brought into no contact with one another and arranged so that electric current is efficiently produced from the electric power generating element. These leads may be coated or laminated with a resin for the sake of an increase in insulation and strength or of an improved reliability in heat sealing.

Baglike Container

A baglike container in the invention suffices to be sealed by heat sealing to prevent leakage of an electrolytic solution from an interior of a battery and entry of moisture content from outside the battery. While a resin film having a heat sealing property can be used for seal portions, it is desired that the barrier property be improved by vapor deposition of a metal, coating with plating or the like, or lamination of a metal foil of aluminum or the like. In the case of a metal foil being used, a resin film can be dispensed with when the foil has an adequate thickness, while an aluminum foil having a thickness of several microns to several tens of microns and laminated with a resin is generally used for the sake of lightening. It is desired that a film of polyethylene, polypropylene or the like be laminated on an inner surface of the foil to provide for the heat sealing property and a film of polyethylene terephthalate or stretch nylon be laminated on an outer surface of the foil to provide for an increase in strength.

Various methods of forming a baglike container are applicable, and include a method of double folding a square-cut film sheet and heat sealing three sides thereof, a method of heat sealing both opening portions of a cylindrical-shaped film and the like. FIG. 1 is a view showing an example of a nonaqueous electrolyte battery, of which a baglike container 3 is formed with the use of the former method, and FIG. 2 is a view showing an example of a nonaqueous electrolyte battery, of which a baglike container 3 is formed with the use of the latter method. In either of the methods, an electric power generating element 1 is inserted into a baglike container 3 and leads 2 are taken out of a heat sealed portion 4. A container material is in some cases used in a state of being cut intact while it is also used after a recess conformed to the electric power generating element has been formed by means of a press or the like. It is also possible to cut or bend a surplus container material after heat sealing.

In many cases, heat sealing is carried out by interposing between wire-like heaters container portions being sealed. At this time, it is desired that the heaters be coated by polytetrafluoroethylene or the like so as to prevent a film being a container material from being melt and fused. Planar heating surfaces are in many cases used but irregularities may be formed conformed to a configuration of a battery or leads. Heater temperature is in many cases in the range of 100 to 200° C. but must be higher than a fusing point of a film resin since sealing becomes insufficient when the temperature is below the fusing point. Also, the heat sealing time is in many cases in the range of 1 to 15 seconds. Further, pressure at the time of heat sealing is in many cases in the range of 3 to 100 g/cm². Since the heater temperature, heat sealing time and pressure assume different optimum values depending upon material, thickness, configuration or the like of a container material, however, they are not limited to the above-mentioned ranges. There is also a method of repeating the heat sealing process on the same area several times to provide for more sure sealing.

Other Constituents

An electrolyte may be liquid or gel. The electrolyte includes, as an organic low molecular compound, ethers such as dimethoxyethane, diethyl ether and so on, esters such as ethylene carbonate, propylene carbonate and soon, singularly or in combination. Other additives may be included. LiPF₆, LiClO₄, LiBF₄ and so on are usable as salt contained in the electrolyte.

In the case where the electrolyte is gel, there are no specific limitations on a method of making gel, and a material, but it is desired that the gel contain an electrolytic solution in its polymer component and an electrolytic solution content be 20 wt. percents to 98 wt. percents. When the electrolytic solution content is below 20 wt. percents, the gel itself will become exceedingly low in ionic conductivity and so an adequate ionic conductivity cannot be given to an electrolyte layer when a battery is formed. Also, when the electrolytic solution content is above 98 wt. percents, the gel becomes exceedingly low in strength, so that an effect of forming gel is small. The gel may be mixed with inorganic fine particle such as silica, alumina or the like. This can in some cases make the gel porous to improve ionic conductivity and prevent short circuit between positive electrode plates and negative electrode plates. A polymer component is not specifically limitative but can use a resin such as methacrylate and acrylic monomers, polymer containing as its principal chain monomers such as alkylene oxide, acrylonitrile, ethylene, styrene, vinyl alcohol, vinylpyrrolidone and so on, homopolymer of polyvinylidene fluoride and so on, copolymer or the like.

When the electrolyte is liquid, a separator is necessary. When the electrolyte is gel, a battery in some cases functions even without any separator, in which case a separator may be provided. As the separator, a suitable one having an adequate strength is chosen from insulating porous films, mesh, nonwoven cloth and the like. Although being not limitative, the use of a porous film formed from a thermoplastic resin such as polypropylene, polyethylene or the like is preferable from the point of view in improvement in adhesiveness, enhancement in ionic conductivity and in prevention of short circuit between positive electrode plates and negative electrode plates.

Constitution of a Battery and Configuration of Lead Portions

A battery according to the invention is constructed such that an electric power generating element with positive electrode plates and negative electrode plates laminated on one another is received in a baglike container and leads connected to the positive electrode plates and negative electrode plates, respectively, are taken out of a heat sealed portion of a baglike container. The leads and an inner surface of the baglike container are fixed together by means of a resin. Here, lead portions indicate ones between the electric power generating element and heat sealed portions of the baglike container. Here, an inner surface of the baglike container indicates a battery inside surface except the heat sealed portions of the baglike container.

Fixation of the leads and the inner surface of the baglike container with the use of a resin is effective in suppressing deformation of leads in the case where a battery is subjected to impact or deforming pressure. Not only adhesion of a resin to leads but also fixation of leads to the inner surface of the baglike container becomes further great in suppressing deformation of leads. Further, fixation of leads to the inner surface of the baglike container with the use of a resin provides for a more sure effect.

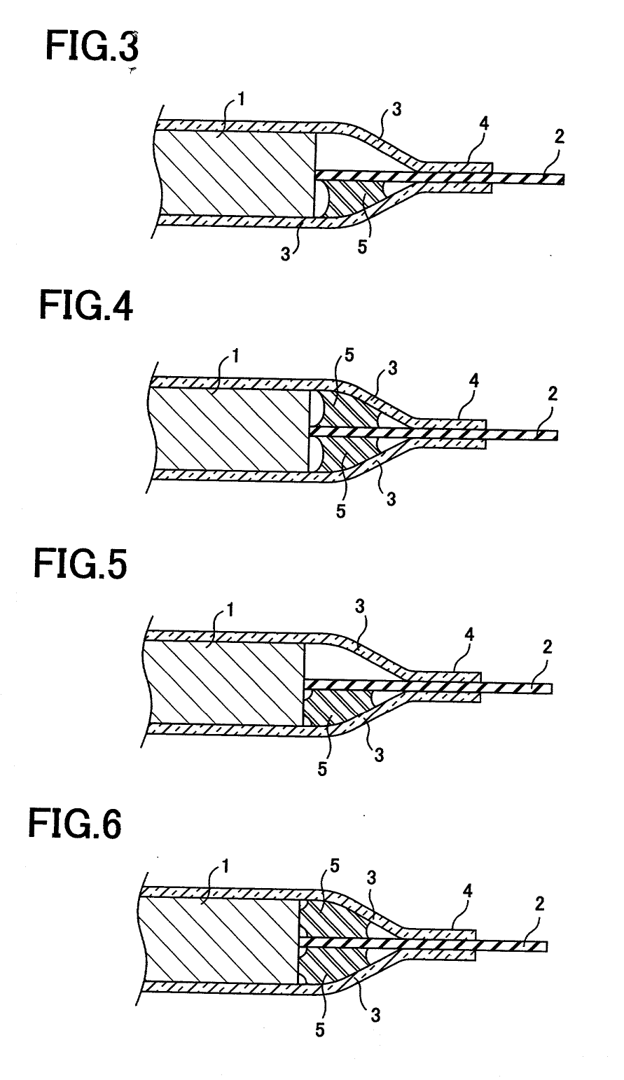

A state of fixation includes the case where one surface of leads 2 and an inner surface of a baglike container 3 are fixed together by means of a resin 5 as shown in FIG. 3 and the case where both surfaces of leads 2 and inner surfaces of the baglike container 3 are fixed together by means of a resin 5 as shown in FIG. 4. While fixation only at one surface of leads as shown in FIG. 3 is adequately effective, a more sure effect is achieved by fixation at both surfaces of leads as shown in FIG. 4. It is not necessary to adhere a resin 5 to entire surfaces of leads but an effect is achieved even in fixation with partial adhesion.

As shown in FIG. 5 or 6, an effect is also achieved in the case where the resin 5 is used to fix the leads 2 to areas of an electric power generating element where positive electrode plates and negative electrode plates are laminated. Adhesion of the resin 5 makes effective use of strength in the laminated portion to be able to suppress deformation of the lead portions.

Method of Manufacturing a Battery

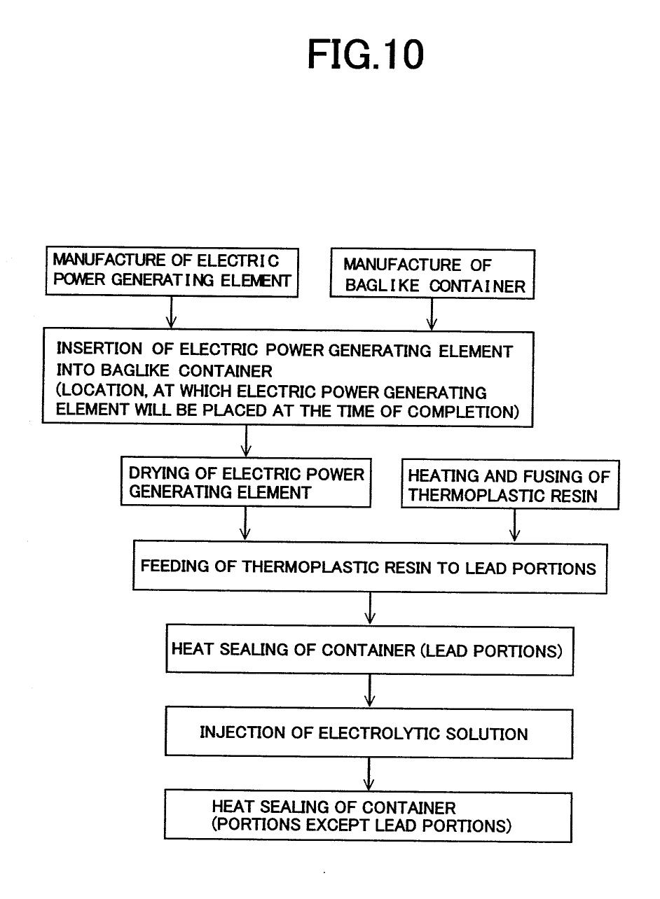

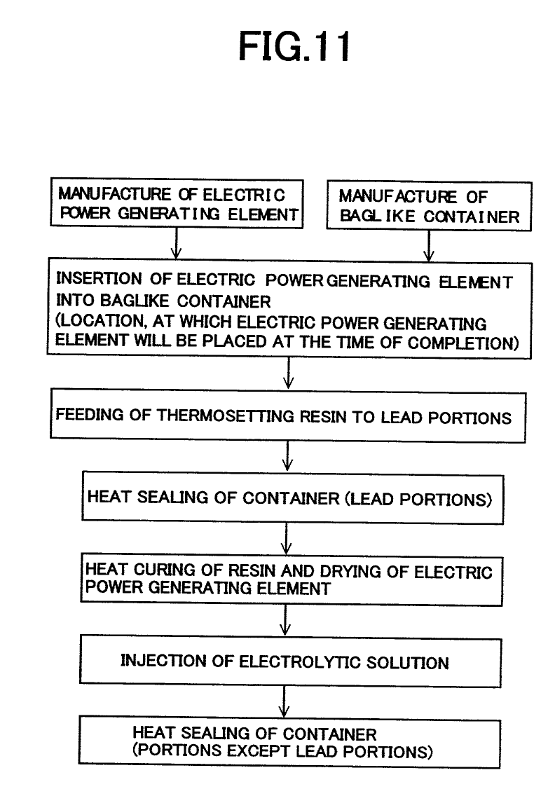

With respect to a method of manufacturing a battery, FIG. 10 shows an example of the manufacture flowchart of a nonaqueous electrolyte battery in the case where a resin in flow condition being supplied to lead portions is a thermoplastic resin. Also, FIG. 11 shows an example of the manufacture flowchart of a nonaqueous electrolyte battery in the case where a resin in flow condition being supplied to lead portions is a thermosetting resin. An explanation will be given below to respective processes.

An electric power generating element with leads connected thereto and a baglike container material cut and formed into a predetermined configuration to enclose therein the electric power generating element and effect heat sealing in a manner to enable manufacture of a battery are beforehand fabricated, and the electric power generating element is arranged in a predetermined position so that leads overlap heat sealed portions of the baglike container material. Thereafter the baglike container is heat sealed to form a battery. There are ways to beforehand impregnate the electric power generating element with an electrolytic solution and to add an electrolytic solution after the element is placed at a predetermined position in the baglike container. With the latter way, the electrolytic solution can be added prior to heat sealing while it can be injected from an area of non-heat sealing after heat sealing is effected to some extent to solidify the configuration of a casing, and such area is subjected to heat sealing for accomplishment.

A resin being fed to lead portions can be fed to lead portions in an optional stage of battery manufacturing processes as long as it is done before heat sealing is effected on portions where leads are taken out of a battery. There are ways to beforehand adhere a resin to leads before placing an electric power generating element in a baglike container and to supply a resin after the electric power generating element is placed at a predetermined position in the baglike container. Even in the case where a resin being used possesses stickiness and is susceptible to deformation or flow to become difficult to handle when it is beforehand adhered to leads, the use of the latter way can advantageously form a battery with ease. Also, a resin having need of heating and drying processes in beforehand adhering to leads is advantageous in that it is inserted into gaps between an electric power generating element and leads to omit surplus processes and to enable easy fixation.

A resin being fed to lead portions can be also supplied in a flow condition. In this case, it becomes possible to easily insert a resin into spaces between a baglike container and leads. There are produced an effect that gaps between the baglike container and the leads are efficiently filled and fixation is made more sure, and also an effect that a battery is reduced in volume and in weight due to reduction of an amount of the resin since fixation is enabled in a less space.

Various kinds of resins are usable except ones that possess no conductivity and are not dissolved in the electrolytic solution. Homopolymer or copolymer can be preferably used to be in many cases highly stable against the electrolytic solution and to include, as its constituent component, for example, olefin derivatives such as ethylene, propylene, isobutylene, propene, butene, 3-methyl-1-butene, cyclohexene or the like, halogenated ethylene derivatives such as polyvinyl chloride, vinylidene chloride, polyvinyl fluoride, polyvinylidene fluoride or the like, diene derivatives such as butadiene, isoprene or the like, styrene derivatives such as styrene, chlorostyrene or the like, vinylester derivatives such as vinyl acetate or the like, vinyl ether derivatives such as methyl vinyl ether, phenyl vinyl ether or the like, derivatives such as acrylic and methacrylate esters, amides or the like, maleate, maleimide derivatives or the like. These resins may be used in a state, in which they are mixed with various solvents, but many of them exhibit plasticity and so can be also used without any solvent.

It is also possible to use resins such as polyphenylene sulfide, polyphenylene oxide, polycarbonate, acetal resin, polyamide or the like. When these resins are to be fed to lead portions, solutions or precursor solutions are used. Some of these resins are excellent in chemical stability, mechanical stability and electrical insulation and thus can be preferably used.

It is also possible to use thermosetting resins such as unsaturated polyester resin, epoxy resin, phenol resin, urea resin, melamine resin, silicone resin, diallyl phthalate resin and so on. When these resins are to be fed to lead portions, solutions or precursor solutions are used. In the case of using these thermosetting resins, it is preferable to perform adequate heat curing. Thereby it is not only possible to adequately lower solubility and swelling property for the electrolytic solution but also to make strength of a resin considerably large, so that protection of lead portions can be more surely effected. When such heat curing is carried out at the time of heat sealing of a baglike container or at the time of drying of an electric power generating element, simplification of processes can be preferably effected.

As described above, multiple resins are usable, and various advantages are produced particularly in the case of using a thermoplastic resin. When melted, a thermoplastic resin can be easily fixed to lead portions and inserted into gaps between the baglike container and leads. Generally, when a polyolefine resin called a hot melt adhesive is used, it can be easily bonded and more surely fixed to inner surfaces of a baglike container, to which ordinary adhesives are frequently difficult to adhere. Further, in the case of using a thermoplastic resin, heat generated at the time of heat sealing of a baglike container is made use of to enable advantageously ensuring fixation of leads and inner surfaces of the baglike container. Since heat generated at the time of heat sealing of the baglike container is transmitted to a thermoplastic resin through a metallic layer of the baglike container having a good thermal conductivity and leads, adherence at inner surfaces of the baglike container and lead surfaces is made favorable to enable sure fixation. In the case of use without any solvent, there are produced advantages that there is no need of any drying process and exhaust equipments or the like and that fixation of leads is made more sure due to no volumetric shrinkage accompanying evaporation of a solvent.

The fusing point of a thermoplastic resin is preferable in the range of 60° C. to 200° C. In the case of the fusing point being below 60° C., there is the possibility that the resin flows at high temperature as when a battery operates. In particular, in the case where a large amount of electrolytic solution is present in a battery, the electrolytic solution is liable to cause a resin to swell to flow. When the fusing point is above 200° C., there is the possibility that heating required for fixation of leads adversely affects the characteristics of a battery. When the fusing point of a thermoplastic resin is in the above range but is lower than the heat sealing temperature of a baglike container, even ordinary heat sealing of the baglike container causes a heat sealed resin to flow, thus obtaining an advantage that sure fixation of leads is made possible without the need of any special heating.

Further, the fusing point of a thermoplastic resin is more preferably in the range of 80° C. to 140° C. with a view to considerably decreasing the possibility that the resin flows at high temperature as when a battery operates and adverse influence on the characteristics of a battery caused by heating required for fixation of leads.

The invention will be explained in more detail with reference to the following examples.

### COMPARATIVE EXAMPLE 1

A positive electrode active material paste made up of LiCoO₂ of 87 wt. percents, graphite powder KS-6 of 8 wt. percents, and polyvinylidene fluoride of 5 wt. percents as a binder resin was coated on an aluminum foil, as a collector, having a thickness of 20 μm by the doctor blade method to have a thickness of about 100 μm, thus forming positive electrode plates.

A negative electrode active material paste made up of mesophase microbead carbon (manufactured by Osaka Gas Ltd.) of 95 wt. percents, and polyvinylidene fluoride of 5 wt. percents as a binder was coated on a copper foil, as a collector, having a thickness of 12 μm by the doctor blade method to have a thickness of about 100 μm, thus forming negative electrode plates.

Manufacture of Electric Power Generating Element

Aluminum leads for the positive electrode plates and nickel leads for the negative electrode plates were manufactured for a collector sized to be of 5 mm×55 mm×0.25 mm, and a denatured polyethylene film having a width of 6 mm was heat sealed to heat sealed portions of an aluminum laminated container. Positive electrode plates and negative electrode plates were cut to have a size of 50 mm×200 mm, and the leads were mounted to a collector foil by means of ultrasonic welding. A separator cut to have a size of 52 mm×210 mm was interposed between the positive electrode plates and the negative electrode plates, wound so that it had a width of about 40 mm and the leads came to its core portion, and fixed by a kapton tape (Kapton is the registered trademark of Du Pont Ltd.). At this time, the leads were put into a state to extend 15 mm from the positive electrode plates and the negative electrode plates thus wound. In this way, a flat electric power generating element to have a size of about 40 mm×50 mm was obtained.

Manufacture of Baglike Containers

An aluminum laminated film cut to a size of 124 mm×58 mm and having polypropylene as a heat sealing resin was double-folded to a size of 62 mm×58 mm, its short sides being heat sealed over a width of 5 mm. Heat sealing was carried out with the use of FCB-270 manufactured by Fuji Impulse Ltd., in which the heater temperature was 180° C., the heat sealing time was 10 seconds, and pressure at the time of heat sealing was 30 g/cm².

Completion of Battery

An electric power generating element was inserted into the baglike container to be sufficiently dried, and the lead portions was subjected to heat sealing. An electrolytic solution containing ethylene carbonate and 1, 2-dimethoxyethane as a solvent and lithium phosphate hexafluoride as an electrolyte was injected from one side not subjected to heat sealing, and an aluminum laminated film was sealed to complete a battery.

Estimation of Impact Resistance

The batteries thus manufactured were dropped on the floor from a level of 1.5 m. Drop with the lead portions downward and drop with the lead portions upward were alternately repeated. After drop was made twenty times, the batteries were disassembled and a state of breakage in the interior of the batteries was examined. As a result, it has been recognized that the lead portions inside three ones among five test batteries were cracked.

### COMPARATIVE EXAMPLE 2

Manufacture of batteries and estimation of impact resistance were conducted in the same manner as in Comparative example 1 except that baglike containers were manufactured in the following way.

Manufacture of Baglike Containers

A recess having a size of 41 mm×55 mm and a depth of 4 mm was formed by means of a press, in a location where an electric power generating element was to be arranged, on an aluminum laminated film cut to a size of 128 mm×60 mm and having polypropylene as a heat sealing resin. The semi-product was double-folded and heat sealed over a width of about 6 mm at short sides. Heat sealing was carried out with the use of FCB-270 manufactured by Fuji Impulse Ltd., in which the heater temperature was 180° C., the heat sealing time was 10 seconds, and pressure at the time of heat sealing was 30 g/cm².

As a result of estimation of impact resistance, it has been recognized that the lead portions inside four ones among five test batteries were cracked.

### EXAMPLE 1

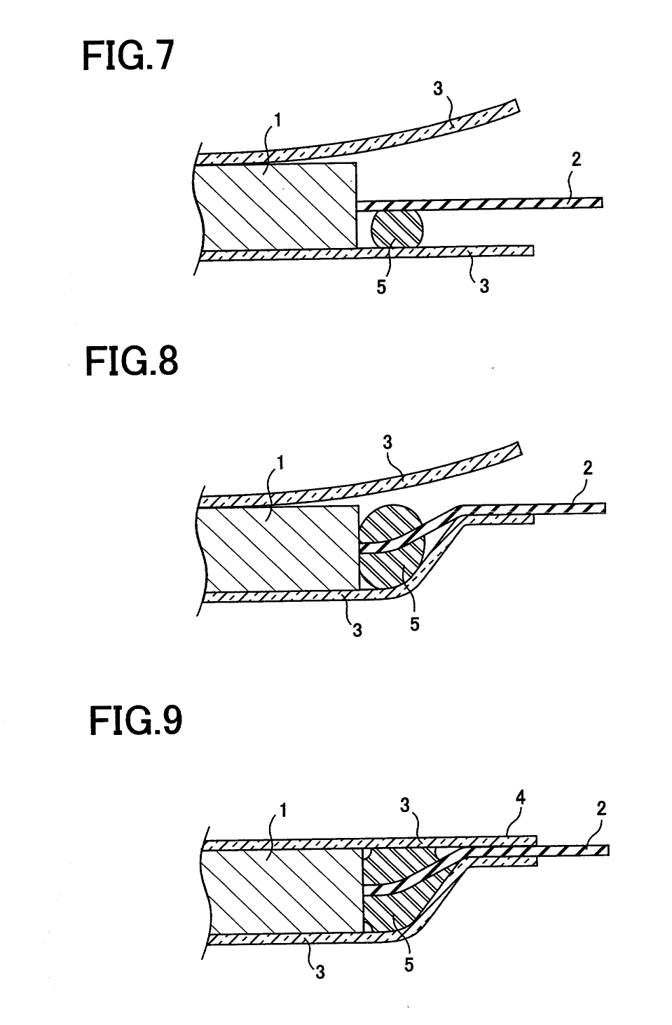

After an electric power generating element having been formed in the same manner as in Comparative example 1 was inserted into a baglike container material to be placed in a location, which would be at the time of completion of a battery, a small amount of polyethylene hot melt resin having a fusing point of 105° C. was discharged from a heating nozzle to be adhered to lead portions near the electric power generating element. At this time, the polyethylene hot melt resin 5 thus adhered was put into a state, in which it was adhered to surfaces of leads 2 and an inside of an aluminum laminated container 3 as shown in FIG. 7.

Thereafter, batteries were completed in the same manner as in Comparative example 1 such that one surfaces of the leads 2 and the inner surface of the baglike container 3 were fixed together as shown in FIG. 3. As a result of estimation of impact resistance, no abnormality was recognized in all five test batteries. In this way, it was confirmed to enable surely protecting leads.

### EXAMPLE 2

After an electric power generating element having been formed in the same manner as in Comparative example 1 was inserted into a baglike container material to be placed in a location, which would be at the time of completion of a battery, a small amount of polyethylene hot melt resin having a fusing point of 86° C. was discharged from a heating nozzle to be adhered to lead portions near the electric power generating element. At this time, the polyethylene hot melt resin 5 thus adhered was put into a state, in which it was adhered to surfaces of leads 2 and an inside of an aluminum laminated container 3 as shown in FIG. 7.

Thereafter, batteries were completed in the same manner as in Comparative example 1 such that both surfaces of the leads 2 and the inner surface of the baglike container 3 were fixed together as shown in FIG. 4. As a result of estimation of impact resistance, no abnormality was recognized in all five test batteries. In this way, it was confirmed to enable surely protecting the leads.

### EXAMPLE 3

After an electric power generating element having been formed in the same manner as in Comparative example 1 was inserted into a baglike container material to be placed in a location, which would be at the time of completion of a battery, a small amount of polyurethane adhesive (Coronate L, Nippon polyurethane) was adhered to lead portions near the electric power generating element. At this time, the polyurethane adhesive 5 thus adhered was put into a state, in which it was adhered to surfaces of leads 2 and an inside of an aluminum laminated container 3 as shown in FIG. 7.

Thereafter, the baglike container was heat sealed and heated for four hours at 80° C. for the purpose of drying of the electric power generating element and heat curing of the polyurethane adhesive, and thus a battery was completed in the same manner as in Comparative example 1, both surfaces of the leads 2 and inner surfaces of the baglike container 3 being fixed together as shown in FIG. 4. As a result of estimation of impact resistance, no abnormality was recognized in all five test batteries. In this way, it was confirmed to enable surely protecting the leads.

### EXAMPLE 4

After an electric power generating element having been formed in the same manner as in Comparative example 2 was inserted into a recess in a baglike container material to be placed in a location, which would be at the time of completion of a battery, a small amount of polyethylene hot melt resin having a fusing point of 86° C. was discharged from a heating nozzle to be adhered to lead portions near the electric power generating element. At this time, the polyethylene hot melt resin 5 thus adhered was put into a state, in which it was adhered to surfaces of leads 2 and an inside of an aluminum laminated container 3 as shown in FIG. 8. Since the resin thus fused was adhered, it was put into a state, in which it was adhered to the leads, the inside of the baglike container and a laminate of the electric power generating elements without deformation of the configuration of the baglike container.

Thereafter, batteries were completed in the same manner as in Comparative example 1 such that both surfaces of the leads 2, the inner surface of the baglike container 3, and the laminate of the electric power generating elements 1 were fixed together. As a result of estimation of impact resistance, no abnormality was recognized in all five test batteries. In this way, it was confirmed to enable surely protecting the leads.

### EXAMPLE 5

After fan electric power generating element having been formed in the same manner as in Comparative example 2 was inserted into a recess in a baglike container material to be placed in a location, which would be at the time of completion of a battery, a small amount of polyurethane adhesive (Coronate L, Nippon Polyurethane) was adhered to lead portions near the electric power generating element. At this time, the polyurethane adhesive 5 thus adhered was put into a state, in which it was adhered to surfaces of leads 2 and an inside of an aluminum laminated container 3 as shown in FIG. 8. Since the resin in a flow condition was adhered, it was put into a state, in which it was adhered to the leads, the inside of the baglike container and a laminate of the electric power generating elements without deformation of the configuration of the baglike container.

Thereafter, the baglike container was heat sealed and heated for four hours at 80° C. for the purpose of drying of the electric power generating element and heat curing of the polyurethane adhesive, and thus a battery was completed in the same manner as in Comparative example 1, both surfaces of the leads 2, inner surfaces of the baglike container 3 and the laminate of the electric power generating elements 1 being fixed together as shown in FIG. 9. As a result of estimation of impact resistance, no abnormality was recognized in all five test batteries. In this way, it was confirmed to enable surely protecting the leads.

According to the invention, a nonaqueous electrolyte battery comprises an electric power generating element, in which leads are connected to positive electrode plates and negative electrode plates, respectively, and laminated, and a baglike container receiving therein the electric power generating element, the leads being taken out of a heat sealed portion of the baglike container, the leads and an inner surface of the baglike container being fixed together by means of a resin so that deformation of the leads upon exertion of impact or deforming pressure on the battery is suppressed to provide a battery which is improved in impact resistance. Not only adhesion of the resin to the leads but also fixation of the leads to the inner surface of the baglike container becomes great in suppressing deformation of the leads.

Further, the leads, the inner surface of the baglike container and the electric power generating element are fixed together by means of a resin whereby deformation of the leads can be more surely suppressed in the case where a battery is subjected to impact or deforming pressure.

By using as a resin a thermoplastic resin having a lower fusing point than the heat sealing temperature of a baglike container, heat generated at the time of heat sealing of the baglike container can cause the thermoplastic resin to flow, so that a battery is obtained, in which heat sealing of the baglike container and fixation of the leads and the inner surface of the baglike container are effected in a packaged process. Since heat generated at the time of heat sealing of the baglike container is transmitted to the thermoplastic resin through a metallic layer of the baglike container having a good thermal conductivity and leads, adherence at inner surfaces of the baglike container and lead surfaces is made favorable to enable sure fixation.

By using as a resin a thermosetting resin having a lower curing temperature than the heat resisting temperatures of all the constituent elements of a battery, a battery is obtained, in which fixation of the leads and the inner surface of the baglike container can be effected in combination with the process of drying of the electric power generating element and curing of the thermosetting resin.

According to the invention, there is provided a method of manufacturing a nonaqueous electrolyte battery comprising an electric power generating element, in which leads are connected to positive electrode plates and negative electrode plates, respectively, and laminated, and a baglike container receiving therein the electric power generating element, the leads being taken out of a heat sealed portion of the baglike container, in the method the leads and an inner surface of the baglike container are fixed together by means of a resin so that deformation of the leads upon exertion of impact or deforming pressure on the battery manufactured is suppressed to provide an improvement in impact resistance of the battery. Not only adhesion of the resin to leads but also fixation of the leads to the inner surface of the baglike container becomes great in suppressing deformation of the leads.

Further, the leads, the inner surface of the baglike container and the electric power generating element are fixed together by means of a resin whereby deformation of the leads can be more surely suppressed in the case where a battery thus manufactured is subjected to impact or deforming pressure.

Also, by feeding a resin to lead portions between the electric power generating element and those portions of the baglike container, which will be heat sealed later, after the electric power generating element has been placed in a location, at which it will be placed at the time of completion of a battery, there is produced an effect that handling is not made difficult and the manufacture of a battery is made easy even in the case where a resin being used possesses stickiness and is susceptible to deformation or flow. Also, a resin having need of heating and drying processes in beforehand adhering to leads is inserted into gaps between the electric power generating element and the lead portions to enable omitting surplus processes and to enable easy fixation.

Further, by feeding to the lead portions a resin in a flow condition, it becomes possible to easily insert the resin into spaces between the baglike container and the leads. Therefore, gaps between the baglike container and the leads are efficiently filled and fixation is made more sure. Also, since fixation can be effected in less spaces, reduction of a battery in volume and reduction in weight can be achieved.

By using as a resin a thermoplastic resin having a lower fusing point than the heat sealing temperature of a baglike container, heat generated at the time of heat sealing of the baglike container can cause the thermoplastic resin to flow, so that heat sealing of the baglike container and fixation of the leads and the inner surface of the baglike container can be effected in a packaged process. Since heat generated at the time of heat sealing of the baglike container is transmitted to the thermoplastic resin through a metallic layer of the baglike container having a good thermal conductivity and the leads, adherence at inner surfaces of the baglike container and lead surfaces is made favorable to enable sure fixation.

By using as a resin a thermosetting resin having a lower curing temperature than the heat resisting temperatures of all constituent elements of the battery, fixation of the leads and the inner surface of the baglike container can be effected in combination with the process of drying of the electric power generating element and curing of the thermosetting resin.

What is claimed is:

1. A nonaqueous electrolyte battery comprising an electric power generating element, in which positive electrode plates and negative electrode plates are laminated, a baglike container receiving therein the electric power generating element and formed from a resin film, leads connected to the positive electrode plates and the negative electrode plates, respectively, and taken out of the baglike container through heat sealed portions of the baglike container, and a resin for fixing the leads and an inner surface of the baglike container together.

2. A nonaqueous electrolyte battery comprising an electric power generating element, in which positive electrode plates and negative electrode plates are laminated, a baglike container receiving therein the electric power generating element and formed from a resin film, leads connected to the positive electrode plates and the negative electrode plates, respectively, and taken out of the baglike container through heat sealed portions, and a resin for fixing the leads, an inner surface of the baglike container and the electric power generating element together.

3. The nonaqueous electrolyte battery according to claim 1, wherein the resin is a thermoplastic resin having a lower fusing point than the heat sealing temperature of the baglike container.

4. The nonaqueous electrolyte battery according to claim 1, wherein the resin is a thermosetting resin having a lower curing temperature than the heat resisting temperatures of all constituent elements of the battery.

5. A method of manufacturing a nonaqueous electrolyte battery comprising an electric power generating element, in which positive electrode plates and negative electrode plates are laminated, a baglike container receiving therein the electric power generating element and formed from a resin film, and leads connected to the positive electrode plates and the negative electrode plates, respectively, and taken out of the baglike container through heat sealed portions of the baglike container, and wherein a resin is used to fix the leads and an inner surface of the baglike container together.

6. The method of manufacturing a nonaqueous electrolyte battery, according to claim 5, wherein the resin is used to fix the leads, the inner surface of the baglike container and the electric power generating element together.

7. The method of manufacturing a nonaqueous electrolyte battery, according to claim 5, wherein the resin is fed to lead portions between the electric power generating element and those portions of the baglike container, which will be heat sealed later, after the electric power generating element has been placed in a location, at which it will be placed at the time of completion of the battery.

8. The method of manufacturing a nonaqueous electrolyte battery, according to claim 5, wherein the resin in a flow condition is fed to the lead portions.

9. The method of manufacturing a nonaqueous electrolyte battery, according to claim 8, wherein the resin is a thermoplastic resin having a lower fusing point than the heat sealing temperature of the baglike container, and heat generated at the time of heat sealing of the baglike container causes the thermoplastic resin to flow.

10. The method of manufacturing a nonaqueous electrolyte battery, according to claim 8, wherein the resin is a thermosetting resin having a lower curing temperature than the heat resisting temperatures of all constituent elements of the battery, and the thermosetting resin is caused to cure after heat stealing of the baglike container.
